(19) United States
(12) Patent Application Publication
(10) Pub. No.: US 2019/0147852 A1
(43) Pub. Date: May 16, 2019

(54) SIGNAL PROCESSING AND SOURCE SEPARATION

(71) Applicant: VocalZoom Systems Ltd., Yokneam Illit (IL)

(72) Inventors: Tal Bakish, Modi'in (IL); Yekutiel Avargel, Nir Galim (IL)

(21) Appl. No.: 15/455,285

(22) PCT Filed: Jul. 21, 2016
(86) PCT No.: PCT/IB2016/054342

§ 371 Date: Mar. 10, 2017

Related U.S. Application Data
(60) Provisional application No. 62/197,022, filed on Jul. 26, 2015.
(60) Provisional application No. 62/197,021, filed on Jul. 26, 2015.

(51) Int. Cl. G10L 15/06; G10L 15/07; G10L 21/0272; G10L 25/06; H04R 23/00; H04R 3/00

(52) U.S. Cl. CPC G10L 15/063; G10L 15/07; H04R 3/005; G10L 25/06; H04R 23/008; G10L 21/0272

(57) ABSTRACT

Device, system, and method of source separation, Blind Source Separation (BSS), signal processing, enhancement of acoustic signals, and reduction of noise from acoustic signals. A first acoustic microphone captures a first acoustic signal at a first location. A second acoustic microphone captures a second acoustic signal at a second location. An optical microphone or laser microphone, that targets or aims towards the first location and not towards the second location, captures an optical feedback signal. One or more correlator units, and one or more de-correlator units, perform particular correlation operations and de-correlation operations, among the first acoustic signal, the second acoustic signal, and the optical feedback signal; and produce, separately, a cleaned or reduced-noise version of the first acoustic signal, as well as a cleaned or reduced-noise version of the second acoustic signal. Optionally, two or more optical microphones or laser microphones are used, to achieve further improved Blind Source Separation.

### CROSS-REFERENCE TO RELATED APPLICATIONS

This patent application claims priority and benefit from U.S. provisional patent application No. 62/197,021, filed on Jul. 26, 2015, which is hereby incorporated by reference in its entirety.

This patent application claims priority and benefit from U.S. provisional patent application No. 62/197,022, filed on Jul. 26, 2015, which is hereby incorporated by reference in its entirety.

### FIELD

The present invention is related to processing of signals.

### BACKGROUND

Audio and acoustic signals are captured and processed by millions of electronic devices. For example, many types of smartphones, tablets, laptop computers, and other electronic devices, may include an acoustic microphone able to capture audio. Such devices may allow the user, for example, to capture an audio/video clip, to record a voice message, to speak telephonically with another person, to participate in telephone conferences or audio/video conferences, to verbally provide speech commands to a computing device or electronic device, or the like.

### SUMMARY

The present invention may comprise, for example, systems, devices, and methods for enhancing and processing audio signals, acoustic signals and/or optical signals.

The present invention may comprise devices, systems, and methods of source separation, Blind Source Separation (BSS), signal processing, enhancement of acoustic signals, and reduction of noise from acoustic signals. For example, a first acoustic microphone captures a first acoustic signal at a first location. A second acoustic microphone captures a second acoustic signal at a second location. An optical microphone or laser microphone, that targets or aims towards the first location and not towards the second location, captures an optical feedback signal. One or more correlator units, and one or more de-correlator units, perform particular correlation operations and de-correlation operations, among the first acoustic signal, the second acoustic signal, and the optical feedback signal; and produce, separately, a cleaned or reduced-noise version of the first acoustic signal, as well as a cleaned or reduced-noise version of the second acoustic signal.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

FIG. 2 is a schematic block-diagram illustration of another system, in accordance with some demonstrative embodiments of the present invention.

FIG. 3 is a schematic illustration of a Blind Source Separation (BSS) system, in accordance with some demonstrative embodiments of the present invention.

FIG. 4 is a schematic block-diagram illustration of an acoustic-and-optical BSS system, in accordance with some demonstrative embodiments of the present invention.

FIG. 5 is a schematic block-diagram illustration of another acoustic-and-optical BSS system, in accordance with some demonstrative embodiments of the present invention.

FIG. 6 is a schematic block-diagram illustration of a system, in accordance with some demonstrative embodiments of the present invention.

### DETAILED DESCRIPTION OF THE PRESENT INVENTION

Applicants have realized that an optical microphone, or a laser-based microphone or a laser-microphone, may be utilized in order to enhance or improve the acoustic signal that is captured by an acoustic microphone, and/or in order to reduce noise from such acoustic signal, and/or in order to separate or differentiate among multiple sources of acoustic signal(s), in one or more ways as described herein.

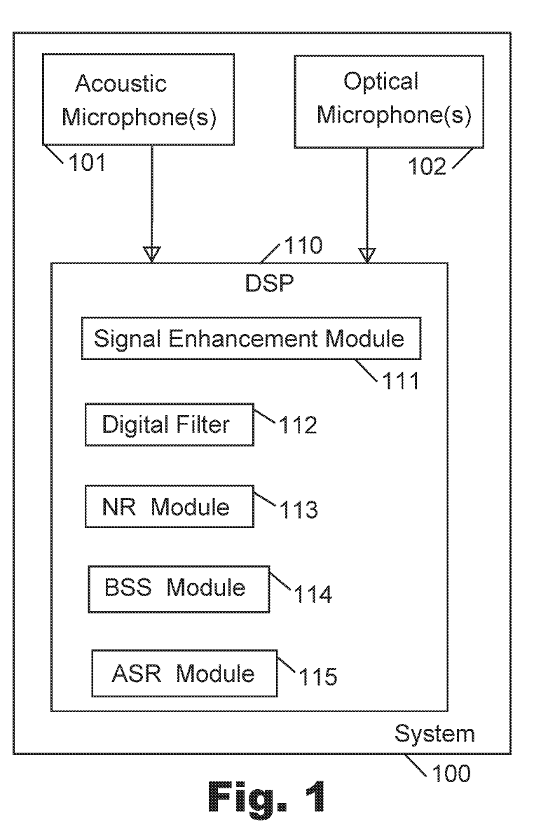

Reference is made to FIG. 1, which is a schematic block-diagram illustration of a system 100 in accordance with some demonstrative embodiments of the present invention. System 100 may be implemented as part of, for example: an electronic device, a smartphone, a tablet, a gaming device, a video-conferencing device, a telephone, a vehicular device, a vehicular system, a vehicular dashboard device, a navigation system, a mapping system, a gaming system, a portable device, a non-portable device, a computer, a laptop computer, a notebook computer, a tablet computer, a server computer, a handheld device, a wearable device, an Augmented Reality (AR) device or helmet or glasses or headset (e.g., similar to Google Glass), a Virtual Reality (VR) device or helmet or glasses or headset (e.g., similar to Oculus Rift), a smart-watch, a machine able to receive voice commands or speech-based commands, a speech-to-text converter, a Voice over Internet Protocol (VoIP) system or device, wireless communication devices or systems, wired communication devices or systems, image processing and/or video processing and/or audio processing workstations or servers or systems, electro-encephalogram (EEG) systems, medical devices or systems, medical diagnostic devices and/or systems, medical treatment devices and/or systems, a voice-controlled system that enables a person to enter (or to pass through) a gate or door or entrance or exit or turnstile, a voice-controlled system that enables a person to ignite a vehicle or to start a vehicle or to open a door of a vehicle or to otherwise control a vehicle, and/or other suitable devices or systems. In some embodiments, system 100 may be implemented as a stand-alone unit or “chip” or module or device, able to capture audio and able to output enhanced audio, clean audio, noise-reduced audio, or otherwise improved or modified audio. System 100 may be implemented by utilizing one or more hardware components and/or software modules.

System 100 may comprise, for example: one or more acoustic microphone(s) 101; and one or more optical microphone(s) 102. Each one of the optical microphone(s) 102 may be or may comprise, for example, a laser-based microphone; which may include, for example, a laser-based transmitter (for example, to transmit a laser beam, e.g., towards a face or a mouth-area of a human speaker or human user, or towards other area-of-interest), an optical sensor to capture optical feedback returned from the area-of-interest; and an optical feedback processor to process the optical feedback and generate a signal (e.g., a stream of data; a data-stream; a data corresponding or imitating or emulating n audio signal or an acoustic signal) that corresponds to that optical feedback.

The acoustic microphone(s) 101 may acquire or sense or capture one or more acoustic signal(s); and the optical microphone(s) 102 may acquire or sense or capture one or more optical signal(s). The signals may be utilized by a digital signal processor (DSP) 110, or other controller or processor or circuit or Integrated Circuit (IC). For example, the DSP 110 may comprise, or may be implemented as, a signal enhancement module 111 able to enhance or improve the acoustic signal based on the received signals; a digital filter 112 (e.g., a digital comb filter, a linear filter, a non-linear filter, or other type(s) of filter(s); which may be part of sub-unit of the signal enhancement module 111, or may be a separate component or module) which may be able to filter the acoustic signal based on the received signals (e.g., based on the received optical feedback signal, or based on the self-mixed signal); a Noise Reduction (NR) module 113 able to reduce noise from the acoustic signal based on the received signals (e.g., based on the received optical feedback signal, or based on the self-mixed signal); a Blind Source Separation (BSS) module 114 able to separate or differentiate among two or more sources of audio, based on the received signals (e.g., based on the received optical feedback signal, or based on the self-mixed signal); a Speech Recognition (SR) or Automatic Speech Recognition (ASR) module 115 able to recognize spoken words based on the received signals (e.g., taking into account the received optical feedback signal, or the self-mixed signal); and/or other suitable modules or sub-modules.

In the discussion herein, the output generated by (or the signals captured by, or the signals processed by) an Acoustic microphone, may be denoted as “A” for Acoustic.

In the discussion herein, the output generated by (or the signals captured by, or the signals processed by) an Optical (or laser-based) microphone, may be denoted as “O” for Optical.

Although portions of the discussion herein may relate to, and although some of the drawings may depict, a single acoustic microphone, or two acoustic microphones, it is clarified that these are merely non-limiting examples of some implementations of the present invention. The present invention may be utilized with, or may comprise or may operate with, other number of acoustic microphones, or a batch or set or group of acoustic microphones, or a matrix or array of acoustic microphones, or the like.

Although portions of the discussion herein may relate to, and although some of the drawings may depict, a single optical (laser-based) microphone, or two optical (laser-based) microphones, it is clarified that these are merely non-limiting examples of some implementations of the present invention. The present invention may be utilized with, or may comprise or may operate with, other number of optical or laser-based microphones, or a batch or set or group of optical or laser-based microphones, or a matrix or array of optical or laser-based microphones, or the like.

Although portions of the discussion herein may relate, for demonstrative purposes, to two “sources” (e.g., two users, or two speakers, or a user and a noise, or a user and interference), the present invention may be used in conjunction with a system having a single source, or having two such sources, or having three or more such sources (e.g., one or more speakers, and/or one or more noise sources or interference sources).

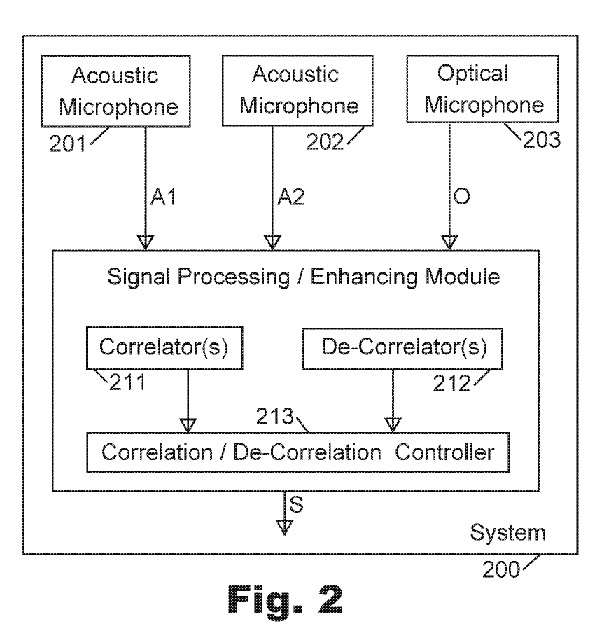

Reference is made to FIG. 2, which is a schematic block-diagram illustration of a system 200 in accordance with some demonstrative embodiments of the present invention. Optionally, system 200 may be a demonstrative implementation of system 100 of FIG. 1.

System 200 may comprise a plurality of acoustic microphones; for example, a first acoustic microphone 201 able to generate a first signal A1 corresponding to the audio captured by the first acoustic microphone 201; and a second acoustic microphone 202 able to generate a second signal A2 corresponding to the audio captured by the second acoustic microphone 202.

System 200 may further comprise one or more optical microphones; for example, an optical microphone 203 aimed towards an area-of-interest, able to generate a signal O corresponding to the optical feedback captured by the optical microphone 203.

A signal processing/enhancing module 210 may receive as input: the first signal A1 of the first acoustic microphone 201, and the second signal A2 of the second acoustic microphone, and also the signal O from the optical microphone. The signal processing/enhancing module 210 may comprise one or more correlator(s) 211, and/or one or more de-correlators 212; which may perform one or more, or a set or series or sequence of, correlation operations and/or de-correlation operations, on the received signals or on some of them or on combination(s) of them, as described herein, based on correlation/decorrelation logic implemented by a correlation/decorrelation controller 213; in order to achieve a particular goal, for example, to reduce noise(s) from acoustic signal(s), to improve or enhance or clean the acoustic signal(s), to distinguish or separate or differentiate among sources of acoustic signals or among speakers, to distinguish or separate or differentiate between a speaker (or multiple speakers) and noise or background noise or ambient noise, to operate as digital filter on one or more of the received signals, and/or to perform other suitable operations. The signal processing/enhancing module 210 may output an enhanced reduced-noise signal S, which may be utilized for the above-mentioned purposes and/or for other purposes, by other units or modules or components of system 200, or by units or components or modules which may be external to (and/or remote from) system 200.

Applicants have realized that conventional Blind Source Separation (BSS) methods, as well as conventional Blind Source Recovery (BSR) methods or conventional Independent Component Analysis (ICA) methods, may not operate adequately with regard to separation of multiple acoustic signals sensed by multiple acoustic microphones. For example, a conventional BSS system may attempt to estimate from observations the independent sources based on statistical differences between the multiple sources.

In a demonstrative BSS system, two signals (S1 and S2) may be generated by two sources, may be subject to noise, and may then be sensed in non-pure state by two sensors which sense or observe signals Y1 and Y2. Each sensor may sense or observe or capture a linear combination of the two signals, for example:

Y1=C1×S1+C2×S2

Y2=C3×S1+C4×S2

In the above, C1, C2, C3 and C4 are unknown; Y1 and Y2 are known (sensed, observed, acquired); and the two original signals S1 and S2 (in their original, pure, clean state) are unknown. The BSS method may iteratively find a matrix M, that when multiplied with the observations (Y1 and Y2) generates two estimated sources that are uncorrelated (e.g., they are statistically independent of each other).

The Applicants have realized that conventional BSS methods may fail when applied to processing of speech signals in real-world acoustic environment; for example, because the multiple sensors (e.g., multiple acoustic microphones) do not observe simple linear combinations of the sources due to echoes, reflections, and other real-life conditions. A complicated “convolutive BSS” may be calculated in the frequency domain; however, in some echoic scenarios, the matrix M is not invertible and thus it may not be possible to separate the sources.

Additionally or alternatively, the Applicants have realized that conventional BSS methods may fail when the acoustic sources share similar statistical characteristics; and/or when two acoustic microphones are used but more than three audio sources are involved (for example, one speaker, a first type of interference, and a second type of interference); and/or when the acoustic signals have similar properties or similar characteristics (e.g., if the spectrum of the interference overlaps the spectrum of the speaker); and/or when operating in an echoic environment; and/or in other real-life scenarios.

In accordance with the present invention, a BSS method and system may be significantly improved and enhanced. For example, in addition to trying to de-correlate among multiple acoustic microphones (namely, finding sources with minimal correlation between them), the BSS method and system may also try to maximize the correlation of one of the multiple acoustic signals (from the multiple acoustic microphones) to an optical signal sensed by an optical microphone (e.g., laser-based microphone). Such correlation/decorrelation operation may boost performance of BSS methods and systems; and may enable such BSS methods and systems to successfully operate in scenarios or environments that caused conventional BSS methods to fail.

Referring again to FIG. 2, in accordance with the present invention, the first acoustic microphone 201 and the second acoustic microphone 202 may sense acoustic signals A1 and A2, respectively. The optical microphone 203 may sense an optical signal O, based on optical feedback received from an area-of-interest that is associated with only one of the multiple speakers or sources. In accordance with the present invention, BSS may be enabled or improved by performing both: (a) de-correlation (or, finding minimum correlation) between the two signals that are sensed by the two acoustic microphones; and (b) correlation (or, finding high correlation, or finding maximum correlation) between (i) one of the two acoustic signals, and (ii) the optical signal sensed by the optical microphone.

For example, two users (U1 and U2) may produce two utterances or sounds or speech-segments or sound-segments (signals S1 and S2). The first acoustic microphone 201 may sense the combination of S1+S2. The second acoustic microphone 202 may also sense the combination of S1+S2. The optical microphone 203 may sense the optical feedback from an area-of-interest associated only with the first user (U1), thereby corresponding to the first signal S1. For example:

Acoustic1=Signal1+Signal2

Acoustic2=Signal1+Signal2

Optical=Signal1

In a first demonstrative implementation, the following BSS method may be utilized. In Step (1), correlate between Optical and Acoustic1, thereby producing Signal1 with noise. In Step (2), de-correlate between Optical and Acoustic2, thereby producing Signal2 with noise. In Step (3), correlate between Optical and Acoustic2, thereby producing Signal1 with noise. In Step (4), de-correlate between Optical and Acoustic1, thereby producing Signal2 with noise. Steps (1) through (4) may be performed in other order(s) or sequence(s). Then, in Step (5), correlation among all the outcomes of steps (1) through (4), or among at least two of those outcomes, may produce (e.g., separately from each other) the clean (noise-reduced) Signal1 and/or the clean (noise-reduced) Signal2.

In a second demonstrative implementation, the following BSS method may be utilized. In Step (1), perform a conventional BSS process with regard to Acoustic1 and Acoustic2. In Step (2), perform correlation and de-correlation between: (i) the outcome of Step (1), and (ii) the Optical signal, thereby producing (e.g., separately from each other) the clean Signal1 and the clean Signal2.

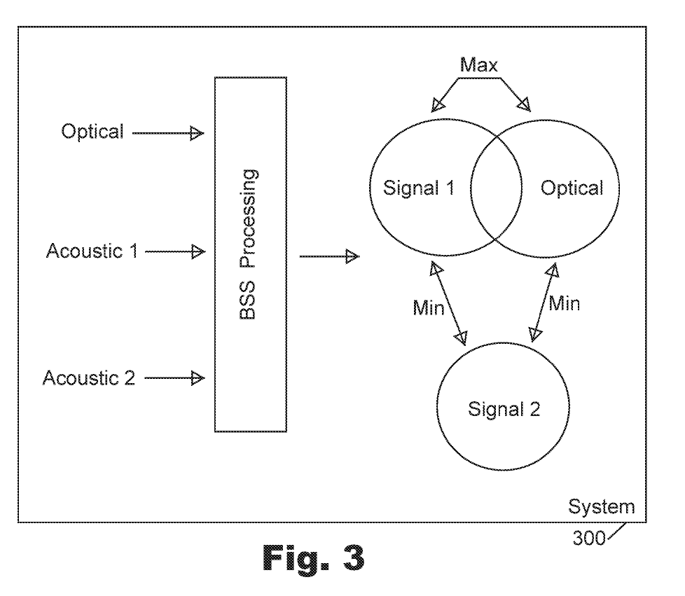

In a third demonstrative implementation, the following BSS method may be utilized, as a one-step method or as an iterative method; which is also demonstrated in the schematic diagram of FIG. 3, which is a schematic illustration of a system 300 in accordance with some demonstrative embodiments of the present invention: Transform Acoustic1 and Acoustic2, to Signal1 and Signal2, such that there would be: (i) de-correlation, or minimal mutual information, or minimal correlation, between Signal1 and Signal2; and (ii) correlation, or maximal mutual information, between Signal1 and Optical; and (iii) de-correlation, or minimal mutual information, or minimal correlation, between Signal2 and Optical.

In some embodiments, the mutual information (or, the correlation) of two discrete random variables X and Y, may be defined as:

$$I ( X ; Y ) = {\sum }_{y ∈ Y} {\sum }_{x ∈ X} p ( x , y ) log ( \frac{p ( x , y )}{p ( x ) p ( y )} ) ,$$

In the above, p(x,y) is the joint probability distribution function of X and Y; and p(x) and p(y) are the marginal probability distribution functions of X and Y, respectively.

In some embodiments, the algorithm may search for the following:

Min{I(S1;S2)+I(S2,O)−I(S1;O)}

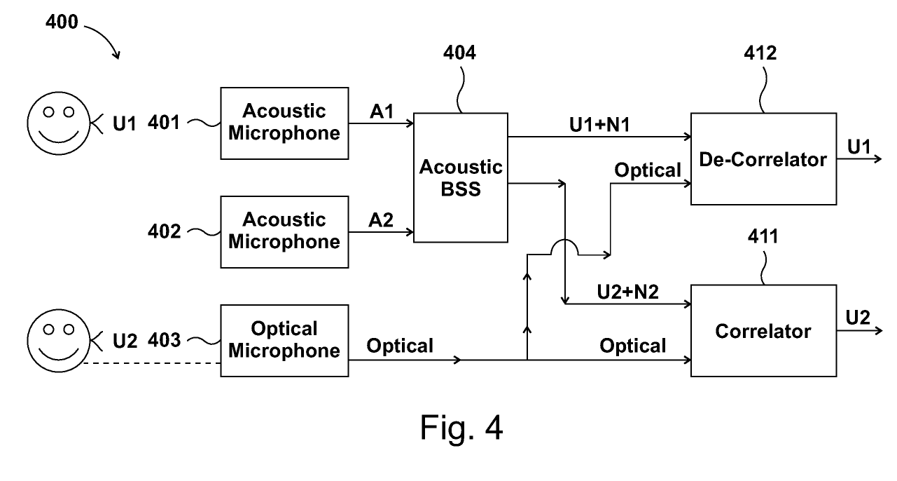

A fourth demonstrative implementation is demonstrated in FIG. 4, which is a schematic block-diagram illustration of an acoustic-and-optical BSS system 400 in accordance with some demonstrative embodiments of the present invention. For example, an acoustic BSS method may be performed; and then, its output may be “cleaned” by utilizing the Optical signal, e.g., by performing both correlation of the optical signal with the “viewed” acoustic signal (namely, the acoustic signal A1 that the optical microphone is aiming towards its estimated source location), and de-correlation of the optical signal with the “non-viewed” acoustic signal (namely, the acoustic signal A2 that is located away from the field-of-view of the aiming zone of the optical microphone).

A first user producing an utterance U1 is shown, as well as a second user producing an utterance U2. A first acoustic microphone 401 may sense acoustic signal A1; a second acoustic microphone 402 may sense acoustic signal A2; and an optical microphone 403 may sense optical feedback from an area-of-interest that is exclusive to only the second user that produced utterance U2 and may produce Optical signal.

As demonstrated, an acoustic BSS module 404 may perform BSS with regard to the two acoustic signals A1 and A2. The acoustic BSS module 404 may output, for example: the signal of utterance U1 plus noise N1; and the signal of utterance U2 plus noise N2. The output of the acoustic BSS module 404 may be utilized for correlation and de-correlation, as follows:

In correlator 411, perform correlation between (i) the optical signal, and (ii) the output of the acoustic BSS module 404 that comprises the signal of utterance U2 plus noise N2; and the output of such correlation would be the clean signal of utterance U2; and also:

In de-correlator 412, perform de-correlation between (i) the optical signal, and (ii) the output of the acoustic BSS module 404 that comprises the signal of utterance U1 plus noise N1; and the output of such de-correlation would be the clean signal of utterance U1.

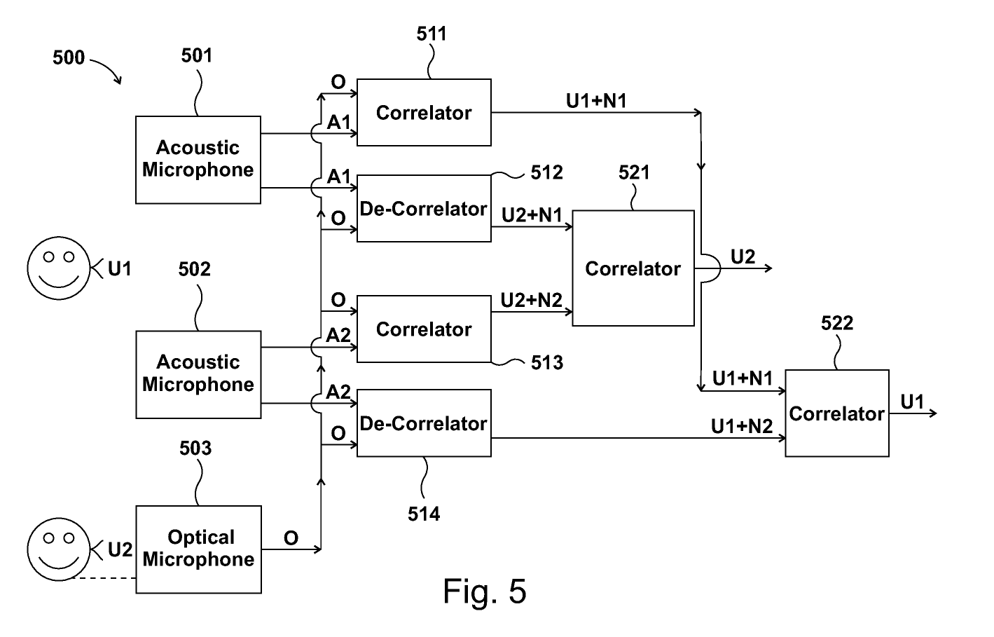

A fifth demonstrative implementation is demonstrated in FIG. 5, which is a schematic block-diagram illustration of an acoustic-and-optical BSS system 500 in accordance with some demonstrative embodiments of the present invention. For example, the system 500 may perform correlation and de-correlation of each acoustic signal with the optical signal; and the outputs may then be correlated in pairs, to receive the clean acoustic signals.

A first user producing an utterance U1 is shown, as well as a second user producing an utterance U2. A first acoustic microphone 501 may sense acoustic signal A1; a second acoustic microphone 502 may sense acoustic signal A2; and an optical microphone 503 may sense optical feedback from an area-of-interest that is exclusive to only the second user that produced utterance U2 and may produce Optical signal.

In a correlator 511, the acoustic signal A1 is correlated with the optical signal; thereby producing the utterance signal U1 with a noise N1.

In a correlator 513, the acoustic signal A2 is correlated with the optical signal; thereby producing the utterance signal U2 with a noise N2.

In a de-correlator 512, the acoustic signal A1 is de-correlated with the optical signal; thereby producing the utterance signal U2 with the noise N1.

In a de-correlator 514, the acoustic signal A2 is de-correlated with the optical signal; thereby producing the utterance signal U1 with the noise N2.

Then, further correlations may be performed on the four outputs of units 511-514. For example: Correlator 521 may correlate between the combination U2+N1 and the combination U2+N2, to produce the clean utterance signal U2. Similarly, Correlator 522 may correlate between the combination U1+N1 and the combination U1+N2, to produce the clean utterance signal U1.

Other suitable circuits, arrangements, and sequences of correlators and/or de-correlators may be used in accordance with demonstrative embodiments of the present invention.

Other implementations may be used in accordance with the present invention. For example, some embodiments may isolate the first human speaker; or may isolate any signal other than the first human speaker (e.g., an interference, an ambient noise, an environmental noise, the utterances of a second speaker, or a combination of noise with utterances of the second speaker, or the like).

In a demonstrative embodiment, the system may be used in order to replace background noises or background speaker(s) of a first type, with background noises or background speaker(s) of a second type. For example, the user may speak to his smartphone in a restaurant with background noise that characterizes restaurants; and the system may isolate the speech, and may add to it background noise that characterizes a different environment (e.g., a soccer game, or a sporting event, or an outdoor venue, or being located in a foreign country).

In some embodiments of the present invention, the BSS methods and elements that are described herein, and/or the other components or modules that are described herein, may be utilized to achieve one or more other (or additional) goals or results or benefits, for example: source separation; speaker identification; overcoming or reducing non-desired reverberation; performing BSS (or improving or enhancing acoustic signals) when one source in known (e.g., not necessarily an optical or laser-based source); performing emotions recognition or mood recognition based on optical (or acoustic-optical or acousto-optical or audio-optical or audio-visual) signal(s); and/or other suitable purposes.

For demonstrative purposes, and in order to not over-crowd the drawings and the circuits shown, portions of the description herein and/or portions of the drawings may show or may relate to a non-limiting example in which a single optical microphone is used. However, the present invention may be utilized in conjunction with or by a system having two (or more) optical microphones or laser microphones or laser-based microphones or laser-based sensors or optical sensors; with a single human speaker, or with two human speakers, or with multiple (or even numerous) human speakers. In some embodiments, K optical microphones may be used, wherein K is a positive integer, to perform BSS with regard to one or more speakers. In other embodiments N optical microphones may be used, wherein N is a positive integer greater than one, to perform BSS with regard to one or more speakers. In other embodiments N optical microphones may be used, wherein N is a positive integer greater than one, to perform BSS with regard to two or more speakers. In other embodiments N optical microphones may be used, wherein N is a positive integer greater than one, to perform BSS with regard to M speakers, wherein N is equal to or greater than N.

In some embodiments, the correlation and/or de-correlation operations that are described above or herein, may be applied to multiple optical signals, to multiple acoustic signals, to multiple self-mixed signals, or to various suitable combinations thereof; wherein at least one signal is acquired by (or generated by) a first optical microphone, and at least one other signal is acquired by (or generated by) a second optical microphone.

In a demonstrative implementation, for example, a system may comprise one or more acoustic microphones; and two optical microphones, such that a first optical microphone is directed towards a first speaker (e.g., directed to a podium in a lecture hall; or directed towards a driver in a vehicle), and a second optical microphone is directed towards a second speaker (e.g., directed towards a sitting panel in that lecture hall; or directed towards a passenger in a vehicle). The system may perform correlation and/or de-correlation methods as described above or herein, with regard to each optical feedback signal (or each self-mixed signal) relative to the acoustic signal, and/or relative to the to the other optical feedback signal (or relative to the other self-mix signal), in order to further enhance the BSS performance. In some implementations, the BSS may perform particularly well if the interference source(s) is (or are) coherent or generally-coherent, and/or if the number of optical sensors is at least equal to (or greater than) the number of sounds sources (e.g., optionally counting a coherent source of interference as a “source” for this purpose).

In another demonstrative implementation, for example, two acoustic microphones may capture two acoustic signals (A1, A2); whereas two optical microphones may capture two optical signals (O1, O2). The BSS unit may search for one or more of the following: (a) correlation between A1 and O1; and/or (b) de-correlation between A1 and O2; and/or (c) correlation between A2 and O2; and/or (d) de-correlation between A2 and O1; and/or (e) de-correlation between A1 and A2. Other suitable circuits or arrangements may be used.

The terms “laser” or “laser transmitter” as used herein may comprise or may be, for example, a stand-alone laser transmitter, a laser transmitter unit, a laser generator, a component able to generate and/or transmit a laser beam or a laser ray, a laser drive, a laser driver, a laser transmitter associated with a modulator, a combination of laser transmitter with modulator, a combination of laser driver or laser drive with modulator, or other suitable component able to generate and/or transmit a laser beam.

The term “acoustic microphone” as used herein, may comprise one or more acoustic microphone(s) and/or acoustic sensor(s); or a matrix or array or set or group or batch or arrangement of multiple such acoustic microphones and/or acoustic sensors; or one or more sensors or devices or units or transducers or converters (e.g., an acoustic-to-electric transducer or converter) able to convert sound into an electrical signal; a microphone or transducer that utilizes electromagnetic induction (e.g., a dynamic microphone) and/or capacitance change (e.g., a condenser microphone) and/or piezoelectricity (e.g., a piezoelectric microphones) in order to produce an electrical signal from air pressure variations; a microphone that may optionally be connected to, or may be associated with or may comprise also, a pre-amplifier or an amplifier; a carbon microphone; a carbon button microphone; a button microphone; a ribbon microphone; an electret condenser microphone; a capacitor microphone; a magneto-dynamic microphone; a dynamic microphone; an electrostatic microphone; a Radio Frequency (RF) condenser microphone; a crystal microphone; a piezo microphone or piezoelectric microphone; and/or other suitable types of audio microphones, acoustic microphones and/or sound-capturing microphones.

The term “laser microphone” as used herein, may comprise, for example: one or more laser microphone(s) or sensor(s); one or more laser-based microphone(s) or sensor(s); one or more optical microphone(s) or sensor(s); one or more microphone(s) or sensor(s) that utilize coherent electromagnetic waves; one or more optical sensor(s) or laser-based sensor(s) that utilize vibrometry, or that comprise or utilize a vibrometer; one or more optical sensor(s) and/or laser-based sensor(s) that comprise a self-mix module, or that utilize self-mixing interferometry measurement technique (or feedback interferometry, or induced-modulation interferometry, or backscatter modulation interferometry), in which a laser beam is reflected from an object, back into the laser, and the reflected light interferes with the light generated inside the laser, and this causes changes in the optical and/or electrical properties of the laser, and information about the target object and the laser itself may be obtained by analyzing these changes.

The terms “vibrating” or “vibrations” or “vibrate” or similar terms, as used herein, refer and include also any other suitable type of motion, and may not necessarily require vibration or resonance per se; and may include, for example, any suitable type of motion, movement, shifting, drifting, slanting, horizontal movement, vertical movement, diagonal movement, one-dimensional movement, two-dimensional movement, three-dimensional movement, or the like.

In some embodiments of the present invention, which may optionally utilize a laser microphone, only “safe” laser beams or sources may be used; for example, laser beam(s) or source(s) that are known to be non-damaging to human body and/or to human eyes, or laser beam(s) or source(s) that are known to be non-damaging even if accidently hitting human eyes for a short period of time. Some embodiments may utilize, for example, Eye-Safe laser, infra-red laser, infra-red optical signal(s), low-strength laser, and/or other suitable type(s) of optical signals, optical beam(s), laser beam(s), infra-red beam(s), or the like. It would be appreciated by persons of ordinary skill in the art, that one or more suitable types of laser beam(s) or laser source(s) may be selected and utilized, in order to safely and efficiently implement the system and method of the present invention. In some embodiments, optionally, a human speaker or a human user may be requested to wear sunglasses or protective eye-gear or protective goggles, in order to provide additional safety to the eyes of the human user which may occasionally be “hit” by such generally-safe laser beam, as an additional precaution.

In some embodiments which may utilize a laser microphone or optical microphone, such optical microphone (or optical sensor) and/or its components may be implemented as (or may comprise) a Self-Mix module; for example, utilizing a self-mixing interferometry measurement technique (or feedback interferometry, or induced-modulation interferometry, or backscatter modulation interferometry), in which a laser beam is reflected from an object, back into the laser. The reflected light interferes with the light generated inside the laser, and this causes changes in the optical and/or electrical properties of the laser. Information about the target object and the laser itself may be obtained by analyzing these changes. In some embodiments, the optical microphone or laser microphone operates to remotely detect or measure or estimate vibrations of the skin (or the surface) of a face-point or a face-region or a face-area of the human speaker (e.g., mouth, mouth-area, lips, lips-area, cheek, nose, chin, neck, throat, ear); and/or to remotely detect or measure or estimate the direct changes in skin vibrations; rather than trying to measure indirectly an effect of spoken speech on a vapor that is exhaled by the mouth of the speaker, and rather than trying to measure indirectly an effect of spoken speech on the humidity or relative humidity or gas components or liquid components that may be produced by the mouth due to spoken speech.

The present invention may be utilized in, or with, or in conjunction with, a variety of devices or systems that may benefit from noise reduction and/or speech enhancement; for example, a smartphone, a cellular phone, a cordless phone, a video conference system or device, a tele-conference system or device, an audio/video camera, a web-camera or web-cam, a landline telephony system, a cellular telephone system, a voice-messaging system, a Voice-over-IP system or network or device, a vehicle, a vehicular dashboard, a vehicular audio system or microphone, a navigation device or system, a vehicular navigation device or system, a mapping or route-guidance device or system, a vehicular route-guidance or device or system, a dictation system or device, Speech Recognition (SR) device or module or system, Automatic Speech Recognition (ASR) module or device or system, a speech-to-text converter or conversion system or device, a laptop computer, a desktop computer, a notebook computer, a tablet, a phone-tablet or “phablet” device, a gaming device, a gaming console, a wearable device, a smart-watch, a Virtual Reality (VR) device or helmet or glasses or headgear, an Augmented Reality (AR) device or helmet or glasses or headgear, an Internet of Things (IoT) device or appliance, an Internet-connected device or appliance, a wireless-connected device or appliance, a device or system or module that utilizes speech-based commands or audio commands, a device or system that captures and/or records and/or processes and/or analyzes audio signals and/or speech and/or acoustic signals, and/or other suitable systems and devices.

Some embodiments of the present invention may provide or may comprise a laser-based device or apparatus or system, a laser-based microphone or sensor, a laser microphone or sensor, an optical microphone or sensor, a hybrid acoustic-optical sensor or microphone, a combined acoustic-optical sensor or microphone, and/or a system that comprises or utilizes one or more of the above.

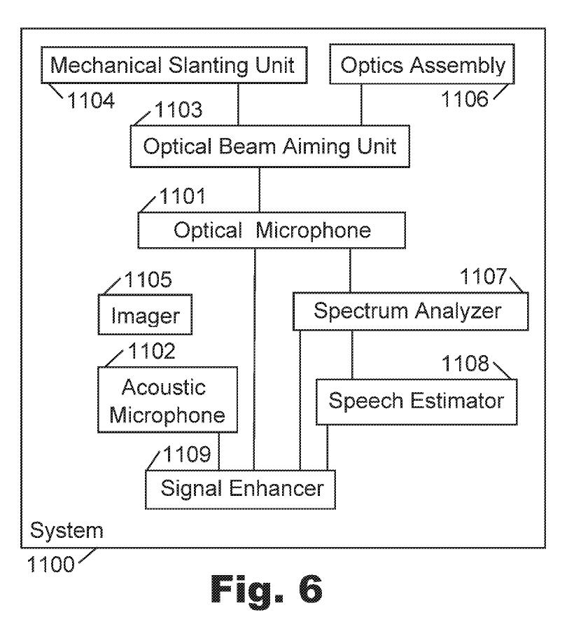

Reference is made to FIG. 6, which is a schematic block-diagram illustration of a system 1100, in accordance with some demonstrative embodiments of the present invention.

System 1100 may comprise, for example, an optical microphone 1101 able to transmit an optical beam (e.g., a laser beam) towards a target (e.g., a face of a human speaker), and able to capture and analyze the optical feedback that is reflected from the target, particularly from vibrating regions or vibrating face-regions or face-portions of the human speaker. The optical microphone 1101 may be or may comprise or may utilize a Self-Mix (SM) chamber or unit, an interferometry chamber or unit, an interferometer, a vibrometer, a targeted vibrometer, or other suitable component, able to analyze the spectrum of the received optical signal with reference to the transmitted optical beam, and able to remotely estimate the audio or speech or utterances generated by the target (e.g., the human speaker).

Optionally, system 1100 may comprise an acoustic microphone 1102 or an audio microphone, which may capture audio. Optionally, the analysis results of the optical feedback may be utilized in order to improve or enhance or filter the captured audio signal; and/or to reduce or cancel noise(s) from the captured audio signal. Optionally, system 1100 may be implemented as a hybrid acoustic-and-optical sensor, or as a hybrid acoustic-and-optical sensor. In other embodiments, system 1100 need not necessarily comprise an acoustic microphone. In yet other embodiments, system 1100 may comprise optical microphone 1102 and may not comprise any acoustic microphones, but may operate in conjunction with an external or a remote acoustic microphone.

System 1100 may further comprise an optical beam aiming unit 1103 (or tilting unit, or slanting unit, or positioning unit, or targeting unit, or directing unit), for example, implemented as a laser beam directing unit or aiming unit or other unit or module able to direct a transmitted optical beam (e.g., a transmitted laser beam) towards the target, and/or able to fine-tune or modify the direction of such optical beam or laser beam. The directing or alignment of the optical beam or laser beam, towards the target, may be performed or achieved by using one or more suitable mechanisms.

In a first example, the optical microphone 1101 may be fixedly mounted or attached or located at a first location or point (e.g., on a vehicular dashboard; on a frame of a screen of a laptop computer), and may generally point or be directed towards an estimated location or a general location of a human speaker that typically utilizes such device (e.g., aiming or targeting an estimated general location of a head of a driver in a vehicle; or aiming or targeting an estimated general location of a head of a laptop computer user); based on a fixed or pre-mounted angular slanting or positioning (e.g., performed by a maker of the vehicular dashboard or vehicle, or by the maker of the laptop computer).

In a second example, the optical microphone may be mounted on a wall of a lecture hall; and may be fixedly pointing or aiming its laser beam or its optical beam towards a general location of a stage or a podium in that lecture hall, in order to target a human speaker who is a lecturer.

In a third example, a motor or engine or robotic arm or other mechanical slanting unit 1104 may be used, in order to align or slant or tilt the direction of the optical beam or laser beam of the optical microphone, towards an actual or an estimated location of a human speaker; optionally via a control interface that allows an administrator to command the movement or the slanting of the optical microphone towards a desired target (e.g., similar to the manner in which an optical camera or an imager or a video-recording device may be moved or tilted via a control interface, a pan-tilt-zoom (PTZ) interface, a robotic arm, or the like).

In a fourth example, an imager 1105 or camera may be used in order to capture images or video of the surrounding of the optical microphone; and a face-recognition module or image-recognition module or a face-identifying module or other Computer Vision algorithm or module may be used in order to analyze the captured images or video and to determine the location of a human speaker (or a particular, desired, human speaker), and to cause the slanting or aiming or targeting or re-aligning of the optical beam to aim towards the identified human speaker. In a fifth example, a human speaker may be requested to wear or to carry a particular tag or token or article or object, having a pre-defined shape or color or pattern which is not typically found at random (e.g., tag or a button showing a green triangle within a yellow square); and an imager or camera may scan an area or a surrounding of system 1100, may analyze the images or video to detect or to find the pre-defined tag, and may aim the optical microphone towards the tag, or towards a pre-defined or estimated offset distance from that tag (e.g., a predefined K degrees of slanting upwardly or vertically relative to the detected tag, if the human speaker is instructed to carry the tag or to wear the tag on his jacket pocket).

In a sixth example, an optics assembly 1106 or optics arrangement (e.g., one or more minors, flat minors, concave minors, convex minors, lenses, prisms, beam-splitters, focusing elements, diffracting elements, diffractive elements, condensing elements, and/or other optics elements or optical elements) may be utilized in order to direct or aim the optical beam or laser beam towards a known or estimated or general location of a target or a speaker or a human face. The optics assembly may be fixedly mounted in advance (e.g., within a vehicle, in order to aim or target a vehicular optical sensor towards a general-location of a driver face), or may be dynamically adjusted or moved or tilted or slanted based on real-time information regarding the actual or estimated location of the speaker or his head (e.g., determined by using an imager, or determined by finding a Signal to Noise Ratio (SNR) value that is greater than a threshold value).

In a seventh example, the optical microphone may move or may “scan” a target area (e.g., by being moved or slanted via the mechanical slanting unit 1104); and may remain at, or may go-back to, a particular direction in which the Signal to Noise Ratio (SNR) value was the maximal, or optimal, or greater than a threshold value.

In an eighth example, particularly if the human speaker is moving on a stage or moving in a room, or moves his face to different directions, the human speaker may be requested or required to stand at a particular spot or location in order to enable the system to efficiently work (e.g., similarly to the manner in which a singer or a performer is required to stand in proximity to a wired acoustic microphone which is mounted on a microphone stand); and/or the human speaker may be requested or required to look to a particular direction or to move his face to a particular direction (e.g., to look directly towards the optical microphone) in order for the system to efficiently operate (e.g., similar to the manner in which a singer or a performer may be requested to look at a camera or a video-recorder, or to put his mouth in close proximity to an acoustic microphone that he holds).

Other suitable mechanisms may be used to achieve or to fine-tune aiming, targeting and/or aligning of the optical beam with the desired target.

It is clarified that the optical microphone and/or the system of the present invention, need not be continuously aligned with the target or the human speaker, and need not necessarily “hit” the speaker continuously with laser beam or optical beam. Rather, in some embodiments, the present invention may operate only during time-periods in which the optical beam or laser beam actually “hits” the face of the speaker, or actually causes reflection of optical feedback from vibrating face-regions of the human speaker. In some embodiments, the system may operate or may efficiently operate at least during time period(s) in which the laser beam(s) or the optical signal(s) actually hit (or reach, or touch) the face or the mouth or the mouth-region of a speaker; and not in other time-periods or time-slots. In some embodiments, the system and/or method need not necessarily provide continuous speech enhancement or continuous noise reduction or continuous speech detection; but rather, in some embodiments the speech enhancement and/or noise reduction and/or speech detection may be achieved in those specific time-periods in which the laser beam(s) actually hit the face of the speaker and cause a reflection of optical feedback from vibrating surfaces or face-regions. In some embodiments, the system may operate only during such time periods (e.g., only a few minutes out of an hour; or only a few seconds out of a minute) in which such actual “hit” of the laser beam with the face-region is achieved. In other embodiments, continuous or substantially-continuous noise reduction and/or speech enhancement may be achieved; for example, in a vehicular system in which the laser beam is directed towards the location of the head or the face of the driver.

In accordance with the present invention, the optical microphone 1101 may comprise a self-mix chamber or unit or self-mix interferometer or a targeted vibrometer, and may utilize reflected optical feedback (e.g., reflected feedback of a transmitted laser beam) in order to remotely measure or estimate vibrations of the facial skin or facial-regions head-regions of a human speaker, utilizing a spectrum analyzer 1107 in order to analyze the optical feedback with reference to the transmitted optical feedback, and utilizing a speech estimator unit 1108 to estimate or extract a signal that corresponds to speech or audio that is generated or uttered by that human speaker.

Optionally, system 1100 may comprise a signal enhancer 1109, which may enhance, filter, improve and/or clean the acoustic signal that is captured by acoustic microphone 1102, based on output generated by the optical microphone 1101. For example, system 1100 may dynamically generate and may dynamically apply, to the acoustic signal captured by the acoustic microphone 1102, a digital filter which may be dynamically constructed by taking into account the output of the optical microphone 1101, and/or by taking into account an analysis of the optical feedback or optical signal(s) that are reflected back from the face of the human speaker.

System 1100 may further comprise any, or some, or all, of the components and/or systems that are depicted in any of FIGS. 1-5, and/or that are discussed with reference to FIGS. 1-5 and/or above and/or herein.

The present invention may be utilized in conjunction with one or more types of acoustic samples or data samples, or a voice sample or voice print, which may not necessarily be merely an acoustic recording or raw acoustic sounds, and/or which may not necessarily be a cleaned or digitally-cleaned or filtered or digitally-filtered acoustic recording or acoustic data. For example, the present invention may utilize, or may operate in conjunction with, in addition to or instead of the other samples or data as described above, one or more of the following: (a) the speech signal, or estimated or detected speech signal, as determined by the optical microphone 1101 based on an analysis of the self-mixed optical signals; (b) an acoustic sample as captured by the acoustic microphone 1102, by itself and/or in combination with the speech signal estimated by the optical microphone 1101; (c) an acoustic sample as captured by the acoustic microphone 1102 and as cleaned or digitally-cleaned or filtered or digitally-filtered or otherwise digitally-adjusted or digitally-modified based on the speech signal estimated by the optical microphone 1101; (d) a voice print or speech sample which is acquired and/or produced by utilizing one or more biometric algorithms or sub-modules, such as a Neural Network module or a Hidden Markov Model (HMM) unit, which may utilize both the acoustic signal and the optical signal (e.g., the self-mixed signals of the optical microphone 1101) in order to extract more data and/or more user-specific characteristics from utterances of the human speaker.

Some embodiments of the present invention may comprise an optical microphone or laser microphone or a laser-based microphone, or optical sensor or laser sensor or laser-based sensor, which utilizes multiple lasers or multiple laser beams or multiple laser transmitters, in conjunction with a single laser drive component and/or a single laser receiver component, thereby increasing or improving the efficiency of self-mix techniques or module or chamber (or self-mix interferometry techniques or module or chamber) utilized by such optical or laser-based microphone or sensor.

In some embodiments of the present invention, which may optionally utilize a laser microphone or optical microphone, the laser beam or optical beam may be directed to an estimated general-location of the speaker; or to a pre-defined target area or target region in which a speaker may be located, or in which a speaker is estimated to be located. For example, the laser source may be placed inside a vehicle, and may be targeting the general location at which a head of the driver is typically located. In other embodiments, a system may optionally comprise one or more modules that may, for example, locate or find or detect or track, a face or a mouth or a head of a person (or of a speaker), for example, based on image recognition, based on video analysis or image analysis, based on a pre-defined item or object (e.g., the speaker may wear a particular item, such as a hat or a collar having a particular shape and/or color and/or characteristics), or the like. In some embodiments, the laser source(s) may be static or fixed, and may fixedly point towards a general-location or towards an estimated-location of a speaker. In other embodiments, the laser source(s) may be non-fixed, or may be able to automatically move and/or change their orientation, for example, to track or to aim towards a general-location or an estimated-location or a precise-location of a speaker. In some embodiments, multiple laser source(s) may be used in parallel, and they may be fixed and/or moving.

In some demonstrative embodiments of the present invention, which may optionally utilize a laser microphone or optical microphone, the system and method may efficiently operate at least during time period(s) in which the laser beam(s) or the optical signal(s) actually hit (or reach, or touch) the face or the mouth or the mouth-region of a speaker. In some embodiments, the system and/or method need not necessarily provide continuous speech enhancement or continuous noise reduction; but rather, in some embodiments the speech enhancement and/or noise reduction may be achieved in those time-periods in which the laser beam(s) actually hit the face of the speaker. In other embodiments, continuous or substantially-continuous noise reduction and/or speech enhancement may be achieved; for example, in a vehicular system in which the laser beam is directed towards the location of the head or the face of the driver.

The system(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules. The system(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

Some embodiments of the present invention may comprise, or may utilize, or may be utilized in conjunction with, one or more elements, units, devices, systems and/or methods that are described in U.S. Pat. No. 7,775,113, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,286,493, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,949,118, titled “System and method for robust estimation and tracking the fundamental frequency of pseudo periodic signals in the presence of noise”, which is hereby incorporated by reference in its entirety.

Some embodiments of the present invention may comprise, or may utilize, or may be utilized in conjunction with, one or more elements, units, devices, systems and/or methods that are described in U.S. Pat. No. 9,344,811, titled “System and method for detection of speech related acoustic signals by using a laser microphone”, which is hereby incorporated by reference in its entirety.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

In accordance with some embodiments of the present invention, a system comprises, for example: a first acoustic microphone located at a first location, to sense a first acoustic signal (A1); a second acoustic microphone located at a second location, to sense a second acoustic signal (A2); an optical microphone to acquire an optical signal (O), wherein the optical microphone aims towards an area that includes said first location and excludes said second location; a Blind Source Separation (BSS) unit to enhance at least the first acoustic signal (A1), by performing a combination of both: (i) de-correlation between the first acoustic signal (A1) and the second acoustic signal (A2), and also (ii) correlation between the first acoustic signal (A1) and said optical signal (O).

In some embodiments, the BSS unit is to reduce noises from the first acoustic signal (A1) by finding both (I) minimum correlation between the first acoustic signal (A1) and the second acoustic signal (A2), and (II) maximum correlation between the first acoustic signal (A1) and said optical signal (O).

In some embodiments, the BSS unit is to enhance at least one of the first acoustic signal (A1) and the second acoustic signal (A2) by performing: (a) correlating between the optical signal (O) and the first acoustic signal (A1), to produce a first signal (S1); (b) de-correlating between the optical signal (O) and the second acoustic signal (A2), to produce a second signal (S2); (c) correlating between the optical signal (O) and the second acoustic signal (A2), to produce a third signal (S3); (d) de-correlating between the optical signal (O) and the first acoustic signal (A1), to produce a fourth signal (S4); (e) correlating among at least two of: the first signal (S1), the second signal (S2), the third signal (S3), and the fourth signal (S4), to produce at least one of: a noise-reduced version of the first acoustic signal, and a noise-reduced version of the second acoustic signal.

In some embodiments, the BSS unit is to enhance at least one of the first acoustic signal (A1) and the second acoustic signal (A2) by performing: (a) performing an acoustic-only BSS algorithm with regard to the first acoustic signal (A1) and the second acoustic signal (A2); (b) producing at least one of: a noise-reduced version of the first acoustic signal, and a noise-reduced version of the second acoustic signal, by performing both correlation and de-correlation between: (i) the outcome of step (a), and (ii) the optical signal (O).

In some embodiments, the BSS unit is to enhance at least one of the first acoustic signal (A1) and the second acoustic signal (A2) by performing: transforming the first acoustic signal (A1) into a first transformed signal (S1), and transforming the second acoustic signal (A2) into a second transformed signal (S2); wherein the first and second transformed signals (S1, S2) have all of the following characteristics: (i) de-correlation between the first transformed signal (S1) and the second transformed signal (S2); and also (ii) correlation between the optical signal (O) and the first transformed signal (S1); and also (iii) de-correlation between the optical signal (O) and the second transformed signal (S2).

In some embodiments, the BSS unit is to enhance at least one of the first acoustic signal (A1) and the second acoustic signal (A2) by performing: transforming the first acoustic signal (A1) into a first transformed signal (S1), and transforming the second acoustic signal (A2) into a second transformed signal (S2); wherein the first and second transformed signals (S1, S2) have all of the following characteristics: (i) minimal correlation between the first transformed signal (S1) and the second transformed signal (S2); and also (ii) maximal correlation between the optical signal (O) and the first transformed signal (S1); and also (iii) minimal correlation between the optical signal (O) and the second transformed signal (S2).

In some embodiments, the BSS unit is to enhance at least one of the first acoustic signal (A1) and the second acoustic signal (A2) by performing: transforming the first acoustic signal (A1) into a first transformed signal (S1), and transforming the second acoustic signal (A2) into a second transformed signal (S2); wherein the first and second transformed signals (S1, S2) have all of the following characteristics: (i) minimal mutual information shared between the first transformed signal (S1) and the second transformed signal (S2); and also (ii) maximal mutual information shared between the optical signal (O) and the first transformed signal (S1); and also (iii) minimal mutual information shared between the optical signal (O) and the second transformed signal (S2).

In some embodiments, the BSS unit is configured to perform an acoustic-only BSS algorithm with regard to the first acoustic signal (A1) and the second acoustic signal (A2); wherein the BSS unit is to perform noise reduction of an output of the acoustic-only BSS algorithm, based on said optical signal (O).

In some embodiments, the BSS unit is configured to perform an acoustic-only BSS algorithm with regard to the first acoustic signal (A1) and the second acoustic signal (A2); wherein the BSS unit is to perform noise reduction of an output of the acoustic-only BSS algorithm, based on said optical signal (O), by performing both: (i) correlation between the optical signal (O) and the first acoustic signal (A1), and also (ii) de-correlation between the optical signal (O) and the second acoustic signal (A2).

In some embodiments, the BSS unit is configured to perform an acoustic-only BSS algorithm with regard to the first acoustic signal (A1) and the second acoustic signal (A2), to produce as output: (a) a first signal comprising a first utterance (U1) of a first speaker plus a first noise (N1); (b) a second signal comprising a second utterance (U2) of a second speaker plus a second noise (N2).

In some embodiments, the BSS unit is configured to perform an acoustic-only BSS algorithm with regard to the first acoustic signal (A1) and the second acoustic signal (A2), to produce as output: (a) a first signal (S1) comprising a first utterance (U1) of a first speaker plus a first noise (N1); (b) a second signal (S2) comprising a second utterance (U2) of a second speaker plus a second noise (N2); wherein the BSS unit further comprises: (I) a correlator (411) to perform correlation between (i) the optical signal (O), and (ii) the second signal (S2) that was outputted by the acoustic-only BSS algorithm and which comprises the second utterance (U2) plus the second noise (N2); wherein said correlator is to output a cleaned version of the second utterance (U2); and (II) a de-correlator (412) to perform correlation between (i) the optical signal (O), and (ii) the first signal (S1) that was outputted by the acoustic-only BSS algorithm and which comprises the first utterance (U1) plus the first noise (N1); wherein said de-correlator is to output a cleaned version of the first utterance (U1).

In some embodiments, the BSS unit is configured to perform an acoustic-only BSS algorithm with regard to the first acoustic signal (A1) and the second acoustic signal (A2), to produce as output: (a) a first signal (S1) comprising a first utterance (U1) of a first speaker plus a first noise (N1); (b) a second signal (S2) comprising a second utterance (U2) of a second speaker plus a second noise (N2); wherein the BSS unit further comprises: a correlator (411) to perform correlation between (i) the optical signal (O), and (ii) the second signal (S2) that was outputted by the acoustic-only BSS algorithm and which comprises the second utterance (U2) plus the second noise (N2); wherein said correlator is to output a cleaned version of the second utterance (U2).

In some embodiments, the BSS unit is configured to perform an acoustic-only BSS algorithm with regard to the first acoustic signal (A1) and the second acoustic signal (A2), to produce as output: (a) a first signal (S1) comprising a first utterance (U1) of a first speaker plus a first noise (N1); (b) a second signal (S2) comprising a second utterance (U2) of a second speaker plus a second noise (N2); wherein the BSS unit further comprises: a de-correlator (412) to perform correlation between (i) the optical signal (O), and (ii) the first signal (S1) that was outputted by the acoustic-only BSS algorithm and which comprises the first utterance (U1) plus the first noise (N1); wherein said de-correlator is to output a cleaned version of the first utterance (U1).

In some embodiments, the BSS unit comprises: a set of correlator units, wherein each correlator unit performs correlation between one acoustic signal and the optical signal; a set of de-correlator units, wherein each de-correlator unit performs de-correlation between one acoustic signal and the optical signal; one or more correlator modules, to produce at least one noise-reduced acoustic signal, by correlating between: (I) at least one output of said set of correlator units, and (II) at least one output of said set of correlator units.

In some embodiments, the BSS unit comprises: (a) a first correlator (511) to correlate between the optical signal (O) and the first acoustic signal (A1), to produce a first signal (S1) that comprises a first utterance (U1) with a first noise (N1); and (b) a second correlator (513) to correlate between the optical signal (O) and the second acoustic signal (A2), to produce a second signal (S2) that comprises a second utterance (U2) with a second noise (N2); and (c) a first de-correlator (512) to de-correlate between the optical signal (O) and the first acoustic signal (A1), to produce a third signal (S3) that comprises the second utterance (U2) with the first noise (N1); and (d) a second de-correlator (514) to de-correlate between the optical signal (O) and the second acoustic signal (A2), to produce a fourth signal (S4) that comprises the first utterance (U1) with the second noise (N2).

In some embodiments, the BSS unit further comprises: (e) a third correlator (521) to correlate between: (I) the third signal (S3) which comprises the second utterance (U2) with the first noise (N1), and (II) the second signal (S2) which comprises the second utterance (U2) with the second noise (N2), to produce a noise-reduced version of the second utterance (U2).

In some embodiments, the BSS unit further comprises: (e) a third correlator (521) to correlate between: (I) the third signal (S3) which comprises the second utterance (U2) with the first noise (N1), and (II) the second signal (S2) which comprises the second utterance (U2) with the second noise (N2), to produce a noise-reduced version of the second utterance (U2); and (f) a fourth correlator (522) to correlate between: (I) the first signal (S1) which comprises the first utterance (U1) with the first noise (N1), and (II) the fourth signal (S4) which comprises the first utterance (U1) with the second noise (N2), to produce a noise-reduced version of the first utterance (U1).

In some embodiments, the BSS unit is to perform correlation operations by utilizing the following formula,

$$I ( X ; Y ) = {\sum }_{y ∈ Y} {\sum }_{x ∈ X} p ( x , y ) log ( \frac{p ( x , y )}{p ( x ) p ( y )} ) ,$$

wherein I is the mutual information between two discrete random variables (X, Y); wherein p(x,y) is the joint probability distribution function of X and Y; wherein p(x) is the marginal probability distribution function of X; wherein p(y) is the marginal probability distribution function of Y.

In some embodiments, the BSS unit is to perform correlation operations by searching for the following minimum value:

Min{I(S1;S2)+I(S2;O)−I(S1;O)}

In some embodiments, said optical microphone comprises: a first optical microphone, directed towards an estimated location of a first sound source; a second optical microphone, directed towards an estimated location of a second sound source; wherein the Blind Source Separation (BSS) unit is to enhance at least the first acoustic signal (A1), by performing a combination of both: (I) de-correlation between the first acoustic signal (A1) and the second acoustic signal (A2), and also (II) correlation between the first acoustic signal (A1) and at least one of two optical self-mix signals produced by said first and second optical microphones.

In some embodiments, said optical microphone comprises: a first optical microphone, directed towards an estimated location of a first sound source, to produce a first self-mix signal (O1); a second optical microphone, directed towards an estimated location of a second sound source, to produce a second self-mix signal (O2); wherein the Blind Source Separation (BSS) unit is to enhance at least the first acoustic signal (A1), by performing at least one of: (a) correlation between the first acoustic signal (A1) and the first self-mix signal (O1); (b) de-correlation between the first acoustic signal (A1) and the second self-mix signal (O2); (c) correlation between the second acoustic signal (A2) and second self-mix signal (O2); (d) de-correlation between second acoustic signal (A2) and first self-mix signal (O1); (e) de-correlation between the first acoustic signal (A1) and the second acoustic signal (A2).

In some embodiments, said optical microphone comprises: a first optical microphone, directed towards an estimated location of a first sound source, to produce a first self-mix signal (O1); and a second optical microphone, directed towards an estimated location of a second sound source, to produce a second self-mix signal (O2); wherein the Blind Source Separation (BSS) unit is to enhance at least the first acoustic signal (A1), by performing at least two of: (a) correlation between the first acoustic signal (A1) and the first self-mix signal (O1); (b) de-correlation between the first acoustic signal (A1) and the second self-mix signal (O2); (c) correlation between the second acoustic signal (A2) and second self-mix signal (O2); (d) de-correlation between second acoustic signal (A2) and first self-mix signal (O1); (e) de-correlation between the first acoustic signal (A1) and the second acoustic signal (A2).

In some embodiments, said optical microphone comprises: a first optical microphone, directed towards an estimated location of a first sound source, to produce a first self-mix signal (O1); a second optical microphone, directed towards an estimated location of a second sound source, to produce a second self-mix signal (O2); wherein the Blind Source Separation (BSS) unit is to enhance at least the first acoustic signal (A1), by performing all of the following: (a) correlation between the first acoustic signal (A1) and the first self-mix signal (O1); (b) de-correlation between the first acoustic signal (A1) and the second self-mix signal (O2); (c) correlation between the second acoustic signal (A2) and second self-mix signal (O2); (d) de-correlation between second acoustic signal (A2) and first self-mix signal (O1); (e) de-correlation between the first acoustic signal (A1) and the second acoustic signal (A2).

In some embodiments, said optical microphone comprises: a first optical microphone, directed towards an estimated location of a first sound source, to produce a first self-mix signal (O1); and a second optical microphone, directed towards an estimated location of a second sound source, to produce a second self-mix signal (O2); wherein the Blind Source Separation (BSS) unit is to enhance at least the first acoustic signal (A1), by performing de-correlation between the first acoustic signal (A1) and the second acoustic signal (A2), and by perform also at least one of: (a) correlation between the first acoustic signal (A1) and the first self-mix signal (O1); (b) de-correlation between the first acoustic signal (A1) and the second self-mix signal (O2); (c) correlation between the second acoustic signal (A2 ) and second self-mix signal (O2); (d) de-correlation between second acoustic signal (A2) and first self-mix signal (O1).

In some embodiments, the system is a hybrid acoustic-and-optical sensor.

In some embodiments, the system is a hybrid acoustic-and-optical sensor that is comprised in an apparatus selected from the group consisting of: a laptop computer, a smartphone, a tablet, a portable electronic device, a vehicular audio system.

The present invention may comprise device, system, and method of source separation, Blind Source Separation (BSS), signal processing, enhancement of acoustic signals, and reduction of noise from acoustic signals. For example, a first acoustic microphone captures a first acoustic signal at a first location. A second acoustic microphone captures a second acoustic signal at a second location. An optical microphone or laser microphone, that targets or aims towards the first location and not towards the second location, captures an optical feedback signal. One or more correlator units, and one or more de-correlator units, perform particular correlation operations and de-correlation operations, among the first acoustic signal, the second acoustic signal, and the optical feedback signal; and produce, separately, a cleaned or reduced-noise version of the first acoustic signal, as well as a cleaned or reduced-noise version of the second acoustic signal. Optionally, two or more optical microphones or laser microphones are used, to achieve further improved Blind Source Separation.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A system comprising:
a first acoustic microphone located at a first location, to sense a first acoustic signal (A1);
a second acoustic microphone located at a second location, to sense a second acoustic signal (A2);
an optical microphone to acquire an optical signal (O), wherein the optical microphone aims towards an area that includes said first location and excludes said second location;
a Blind Source Separation (BSS) unit to enhance at least the first acoustic signal (A1), by performing a combination of both: (i) de-correlation between the first acoustic signal (A1) and the second acoustic signal (A2), and also (ii) correlation between the first acoustic signal (A1) and said optical signal (O).

2. The system of claim 1, wherein the BSS unit is to reduce noises from the first acoustic signal (A1) by finding both (I) minimum correlation between the first acoustic signal (A1) and the second acoustic signal (A2), and (II) maximum correlation between the first acoustic signal (A1) and said optical signal (O).

3. The system of claim 1, wherein the BSS unit is to enhance at least one of the first acoustic signal (A1) and the second acoustic signal (A2) by performing:
(a) correlating between the optical signal (O) and the first acoustic signal (A1), to produce a first signal (S1);
(b) de-correlating between the optical signal (O) and the second acoustic signal (A2), to produce a second signal (S2);
(c) correlating between the optical signal (O) and the second acoustic signal (A2), to produce a third signal (S3);
(d) de-correlating between the optical signal (O) and the first acoustic signal (A1), to produce a fourth signal (S4);
(e) correlating among at least two of: the first signal (S1), the second signal (S2), the third signal (S3), and the fourth signal (S4), to produce at least one of: a noise-reduced version of the first acoustic signal, and a noise-reduced version of the second acoustic signal.

4. The system of claim 1, wherein the BSS unit is to enhance at least one of the first acoustic signal (A1) and the second acoustic signal (A2) by performing:
(a) performing an acoustic-only BSS algorithm with regard to the first acoustic signal (A1) and the second acoustic signal (A2);
(b) producing at least one of: a noise-reduced version of the first acoustic signal, and a noise-reduced version of the second acoustic signal,
by performing both correlation and de-correlation between: (i) the outcome of step (a), and (ii) the optical signal (O).

5. The system of claim 1, wherein the BSS unit is to enhance at least one of the first acoustic signal (A1) and the second acoustic signal (A2) by performing:
transforming the first acoustic signal (A1) into a first transformed signal (S1),
and
transforming the second acoustic signal (A2) into a second transformed signal (S2),
wherein the first and second transformed signals (S1, S2) have all of the following characteristics:
(i) de-correlation between the first transformed signal (S) and the second transformed signal (S2);
and also
(ii) correlation between the optical signal (O) and the first transformed signal (S1);
and also
(iii) de-correlation between the optical signal (O) and the second transformed signal (S2).

6. The system of claim 1, wherein the BSS unit is to enhance at least one of the first acoustic signal (A1) and the second acoustic signal (A2) by performing:
transforming the first acoustic signal (A1) into a first transformed signal (S1),
and
transforming the second acoustic signal (A2) into a second transformed signal (S2),
wherein the first and second transformed signals (S1, S2) have all of the following characteristics:
(i) minimal correlation between the first transformed signal (S1) and the second transformed signal (S2);
and also
(ii) maximal correlation between the optical signal (O) and the first transformed signal (S1);
and also
(iii) minimal correlation between the optical signal (O) and the second transformed signal (S2).

7. The system of claim 1, wherein the BSS unit is to enhance at least one of the first acoustic signal (A1) and the second acoustic signal (A2) by performing:
transforming the first acoustic signal (A1) into a first transformed signal (S1),
and
transforming the second acoustic signal (A2) into a second transformed signal (S2),
wherein the first and second transformed signals (S1, S2) have all of the following characteristics:
(i) minimal mutual information shared between the first transformed signal (S1) and the second transformed signal (S2);
and also
(ii) maximal mutual information shared between the optical signal (O) and the first transformed signal (S1);
and also
(iii) minimal mutual information shared between the optical signal (O) and the second transformed signal (S2).

8. The system of claim 1, wherein the BSS unit is configured to perform an acoustic-only BSS algorithm with regard to the first acoustic signal (A1) and the second acoustic signal (A2);
wherein the BSS unit is to perform noise reduction of an output of the acoustic-only BSS algorithm, based on said optical signal (O).

9. The system of claim 1, wherein the BSS unit is configured to perform an acoustic-only BSS algorithm with regard to the first acoustic signal (A1) and the second acoustic signal (A2);
wherein the BSS unit is to perform noise reduction of an output of the acoustic-only BSS algorithm, based on said optical signal (O), by performing both: (i) correlation between the optical signal (O) and the first acoustic signal (A1), and also (ii) de-correlation between the optical signal (O) and the second acoustic signal (A2).

10. The system of claim 1, wherein the BSS unit is configured to perform an acoustic-only BSS algorithm with regard to the first acoustic signal (A1) and the second acoustic signal (A2), to produce as output:
(a) a first signal comprising a first utterance (U1) of a first speaker plus a first noise (N1);
(b) a second signal comprising a second utterance (U2) of a second speaker plus a second noise (N2).

11. The system of claim 1, wherein the BSS unit is configured to perform an acoustic-only BSS algorithm with regard to the first acoustic signal (A1) and the second acoustic signal (A2), to produce as output:
(a) a first signal (S1) comprising a first utterance (U1) of a first speaker plus a first noise (N1);
(b) a second signal (S2) comprising a second utterance (U2) of a second speaker plus a second noise (N2);
wherein the BSS unit further comprises:
(I) a correlator (411) to perform correlation between (i) the optical signal (O), and (ii) the second signal (S2) that was outputted by the acoustic-only BSS algorithm and which comprises the second utterance (U2) plus the second noise (N2); wherein said correlator is to output a cleaned version of the second utterance (U2);
(II) a de-correlator (412) to perform correlation between (i) the optical signal (O), and (ii) the first signal (S1) that was outputted by the acoustic-only BSS algorithm and which comprises the first utterance (U1) plus the first noise (N1); wherein said de-correlator is to output a cleaned version of the first utterance (U1).

12. The system of claim 1, wherein the BSS unit is configured to perform an acoustic-only BSS algorithm with regard to the first acoustic signal (A1) and the second acoustic signal (A2), to produce as output:
(a) a first signal (S1) comprising a first utterance (U1) of a first speaker plus a first noise (N1);
(b) a second signal (S2) comprising a second utterance (U2) of a second speaker plus a second noise (N2);
wherein the BSS unit further comprises:
a correlator (411) to perform correlation between (i) the optical signal (O), and (ii) the second signal (S2) that was outputted by the acoustic-only BSS algorithm and which comprises the second utterance (U2) plus the second noise (N2); wherein said correlator is to output a cleaned version of the second utterance (U2).

13. The system of claim 1, wherein the BSS unit is configured to perform an acoustic-only BSS algorithm with regard to the first acoustic signal (A1) and the second acoustic signal (A2), to produce as output:
(a) a first signal (S1) comprising a first utterance (U1) of a first speaker plus a first noise (N1);
(b) a second signal (S2) comprising a second utterance (U2) of a second speaker plus a second noise (N2);
wherein the BSS unit further comprises:
a de-correlator (412) to perform correlation between (i) the optical signal (O), and (ii) the first signal (S1) that was outputted by the acoustic-only BSS algorithm and which comprises the first utterance (U1) plus the first noise (N1); wherein said de-correlator is to output a cleaned version of the first utterance (U1).

14. The system of claim 1, wherein the BSS unit comprises:
a set of correlator units, wherein each correlator unit performs correlation between one acoustic signal and the optical signal;
a set of de-correlator units, wherein each de-correlator unit performs de-correlation between one acoustic signal and the optical signal;
one or more correlator modules, to produce at least one noise-reduced acoustic signal, by correlating between: (I) at least one output of said set of correlator units, and (II) at least one output of said set of correlator units.

15. The system of claim 1, wherein the BSS unit comprises:
(a) a first correlator (511) to correlate between the optical signal (O) and the first acoustic signal (A1), to produce a first signal (S1) that comprises a first utterance (U1) with a first noise (N1);
(b) a second correlator (513) to correlate between the optical signal (O) and the second acoustic signal (A2), to produce a second signal (S2) that comprises a second utterance (U2) with a second noise (N2);
(c) a first de-correlator (512) to de-correlate between the optical signal (O) and the first acoustic signal (A1), to produce a third signal (S3) that comprises the second utterance (U2) with the first noise (N1);
(d) a second de-correlator (514) to de-correlate between the optical signal (O) and the second acoustic signal (A2), to produce a fourth signal (S4) that comprises the first utterance (U1) with the second noise (N2).

16. The system of claim 15, wherein the BSS unit further comprises:
(e) a third correlator (521) to correlate between: (I) the third signal (S3) which comprises the second utterance (U2) with the first noise (N1), and (II) the second signal (S2) which comprises the second utterance (U2) with the second noise (N2), to produce a noise-reduced version of the second utterance (U2).

17. The system of claim 15, wherein the BSS unit further comprises:
(e) a third correlator (521) to correlate between: (I) the third signal (S3) which comprises the second utterance (U2) with the first noise (N1), and (II) the second signal (S2) which comprises the second utterance (U2) with the second noise (N2), to produce a noise-reduced version of the second utterance (U2);
(f) a fourth correlator (522) to correlate between: (I) the first signal (S1) which comprises the first utterance (U1) with the first noise (N1), and (II) the fourth signal (S4) which comprises the first utterance (U1) with the second noise (N2), to produce a noise-reduced version of the first utterance (U1).

18. The system of any one of claims 1-17, wherein the BSS unit is to perform correlation operations by utilizing the following formula,
$$I ( X ; Y ) = {\sum }_{y ∈ Y} {\sum }_{x ∈ X} p ( x , y ) log ( \frac{p ( x , y )}{p ( x ) p ( y )} ) ,$$
wherein I is the mutual information between two discrete random variables (X, Y);
wherein p(x,y) is the joint probability distribution function of X and Y;
wherein p(x) is the marginal probability distribution function of X;
wherein p(y) is the marginal probability distribution function of Y.

19. The system of claim 18, wherein the BSS unit is to perform correlation operations by searching for the following minimum value:
Min{I(S1;S2)+I(S2;O)−I(S1;O)}

20. The system of claim 1, wherein said optical microphone comprises:
a first optical microphone, directed towards an estimated location of a first sound source;
a second optical microphone, directed towards an estimated location of a second sound source;
wherein the Blind Source Separation (BSS) unit is to enhance at least the first acoustic signal (A1), by performing a combination of both: (I) de-correlation between the first acoustic signal (A1) and the second acoustic signal (A2), and also (II) correlation between the first acoustic signal (A1) and at least one of two optical self-mix signals produced by said first and second optical microphones.

21. The system of claim 1, wherein said optical microphone comprises:
a first optical microphone, directed towards an estimated location of a first sound source, to produce a first self-mix signal (O1);
a second optical microphone, directed towards an estimated location of a second sound source, to produce a second self-mix signal (O2);
wherein the Blind Source Separation (BSS) unit is to enhance at least the first acoustic signal (A1), by performing at least one of:
(a) correlation between the first acoustic signal (A1) and the first self-mix signal (O1);
(b) de-correlation between the first acoustic signal (A1) and the second self-mix signal (O2);
(c) correlation between the second acoustic signal (A2) and second self-mix signal (O2);
(d) de-correlation between second acoustic signal (A2) and first self-mix signal (O1);
(e) de-correlation between the first acoustic signal (A1) and the second acoustic signal (A2).

22. The system of claim 1, wherein said optical microphone comprises:
a first optical microphone, directed towards an estimated location of a first sound source, to produce a first self-mix signal (O1);
a second optical microphone, directed towards an estimated location of a second sound source, to produce a second self-mix signal (O2);
wherein the Blind Source Separation (BSS) unit is to enhance at least the first acoustic signal (A1), by performing at least two of:
(a) correlation between the first acoustic signal (A1) and the first self-mix signal (O1);
(b) de-correlation between the first acoustic signal (A1) and the second self-mix signal (O2);
(c) correlation between the second acoustic signal (A2) and second self-mix signal (O2);
(d) de-correlation between second acoustic signal (A2) and first self-mix signal (O1);
(e) de-correlation between the first acoustic signal (A1) and the second acoustic signal (A2).

23. The system of claim 1, wherein said optical microphone comprises:
a first optical microphone, directed towards an estimated location of a first sound source, to produce a first self-mix signal (O1);
a second optical microphone, directed towards an estimated location of a second sound source, to produce a second self-mix signal (O2);
wherein the Blind Source Separation (BSS) unit is to enhance at least the first acoustic signal (A1), by performing all of the following:
(a) correlation between the first acoustic signal (A1) and the first self-mix signal (O1);
(b) de-correlation between the first acoustic signal (A1) and the second self-mix signal (O2);
(c) correlation between the second acoustic signal (A2) and second self-mix signal (O2);
(d) de-correlation between second acoustic signal (A2) and first self-mix signal (O1);
(e) de-correlation between the first acoustic signal (A1) and the second acoustic signal (A2).

24. The system of claim 1, wherein said optical microphone comprises:
a first optical microphone, directed towards an estimated location of a first sound source, to produce a first self-mix signal (O1);
a second optical microphone, directed towards an estimated location of a second sound source, to produce a second self-mix signal (O2);
wherein the Blind Source Separation (BSS) unit is to enhance at least the first acoustic signal (A1), by performing de-correlation between the first acoustic signal (A1) and the second acoustic signal (A2), and by perform also at least one of:
(a) correlation between the first acoustic signal (A1) and the first self-mix signal (O1);
(b) de-correlation between the first acoustic signal (A1) and the second self-mix signal (O2);
(c) correlation between the second acoustic signal (A2) and second self-mix signal (O2);
(d) de-correlation between second acoustic signal (A2) and first self-mix signal (O1).

25. The system of claim 1, wherein the system is a hybrid acoustic-and-optical sensor.

26. The system of claim 1, wherein the system is a hybrid acoustic-and-optical sensor that is comprised in an apparatus selected from the group consisting of: a laptop computer, a smartphone, a tablet, a portable electronic device, a vehicular audio system.
